(19) United States
(12) Patent Application Publication
(10) Pub. No.: US 2015/0022730 A1
(43) Pub. Date: Jan. 22, 2015

(54) TOUCH DISPLAY PANEL

(71) Applicant: Ye Xin Technology Consulting Co.,, Hsinchu (TW)

(72) Inventors: WEI-CHIH CHANG, Hsinchu (TW); JUN GOTOH, Hsinchu (TW); KUAN-HSIEN JIANG, Hsinchu (TW)

(73) Assignee: YE XIN TECHNOLOGY CONSULTING CO., LTD., Hsinchu (TW)

(21) Appl. No.: 14/135,464

(22) Filed: Dec. 19, 2013

(30) Foreign Application Priority Data
Jul. 18, 2013 (TW) 102125833

(51) Int. Cl. G02F 1/1333

(52) U.S. Cl. CPC G02F 1/13338
USPC 349/12

(57) ABSTRACT

A touch display panel includes an LCD panel and a touch structure formed on the LCD panel. The LCD panel includes a first substrate, a second substrate and a liquid crystal layer formed between the first substrate and the second substrate. A color filter is formed on a bottom surface of the first substrate adjacent to the liquid crystal layer. A touch structure is formed on the LCD panel. The touch structure includes a first transparent ITO film. The first transparent ITO film defines a plurality of channels thereon. A photo etching barrier layer is formed between the first transparent ITO film and the color filter. The photo etching barrier layer is configured to prevent the channels from extending to the color filter and the liquid crystal layer.

### BACKGROUND

1. Technical Field

The disclosure generally relates to a display panel, and particularly relates to a touch display panel with a high reliability.

2. Description of Related Art

In recent years, touch panels have been widely used in electronic products such as mobile phones, personal digital assistants (PDAs) and note books. To meet demands of portable, compact, and user-friendly, display panels having touch panels are used in the electronic products.

Generally, a touch panel includes a liquid crystal display (LCD) panel and an indium tin oxide (ITO) film formed on the LCD panel. The ITO film defines a plurality of channels thereon. However, in forming of the channels, if the ITO film is not etched enough, adjacent portions of the ITO film are still connected, thereby affecting the performances of the ITO film; if the ITO film is etched too much, the channels may extend to the color filter and the liquid crystal layer of the LCD panel and affect the performances of the LCD panel.

What is needed, therefore, is a touch display panel to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a cross sectional view of a touch display panel in accordance with a first embodiment of the present disclosure.

FIG. 2 is an illustrating view of etching a first transparent film of the touch display panel in FIG. 1.

FIG. 3 is a cross sectional view of a touch display panel in accordance with a second embodiment of the present disclosure.

FIG. 4 is a cross sectional view of a touch display panel in accordance with a third embodiment of the present disclosure.

### DETAILED DESCRIPTION

Embodiments of touch display panels will now be described in detail below and with reference to the drawings.

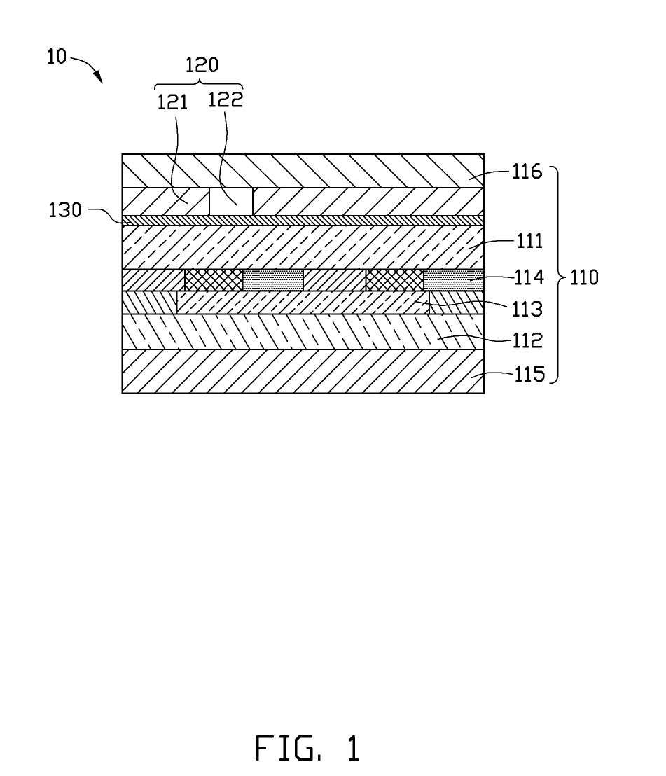

Referring to FIG. 1, a touch display panel 10 in accordance with a first embodiment is provided. The touch display panel 10 includes an LCD panel 110, a touch structure 120 formed on the LCD panel 110, and a photo etching barrier layer 130 formed between the touch structure 120 and the LCD panel 110.

The LCD panel 110 includes a first substrate 111, a second substrate 112 and a liquid crystal layer 113 formed between the first substrate 111 and the second substrate 112. The first substrate 111 and the second substrate 112 are made of glass. A color filter 114 is formed on a bottom surface of the first substrate 111 adjacent to the liquid crystal layer 113 by depositing or coating. A thin film transistor array is formed on an upper surface of the second substrate 112 adjacent to the liquid crystal layer 113 to drive the

LCD panel 110. In this embodiment, a first polarizer 115 is formed on a bottom surface of the second substrate 112 away from the liquid crystal layer 113. A second polarizer 116 is formed on an upper surface of the touch structure 120 away from the LCD panel 110. The first polarizer 115 and the second polarizer 116 are configured to be passed through by a polarized light with a predetermined direction.

The touch structure 120 includes a first transparent ITO film 121. The first transparent ITO film 121 defines a plurality of channels 122 to be patterning.

The photo etching barrier layer 130 is formed on an upper surface of the first substrate 111 adjacent to the touch structure 120. The photo etching barrier layer 130 is configured to prevent the channel 122 in the first transparent ITO film 121 to extend into the LCD panel 110. In this embodiment, the photo etching barrier layer 130 is made of a material to absorb or reflect ultraviolet light or infrared light. The ultraviolet light has a wavelength less than 400 nanometer (nm), and the infrared light has a wavelength larger than 700 nm. The photo etching barrier layer 130 can be made of organics such as polyimide and propyl acetate. Also, the photo etching barrier layer 130 can be an adhesive layer filled with metallic particles. The metallic particles include Al, Cu, Ag, Pd, Ni or alloys thereof. Furthermore, the photo etching barrier layer 130 can be formed by stacking of a plurality of reflective films such as TiO₂ films, ZnO films or SnO₂ films.

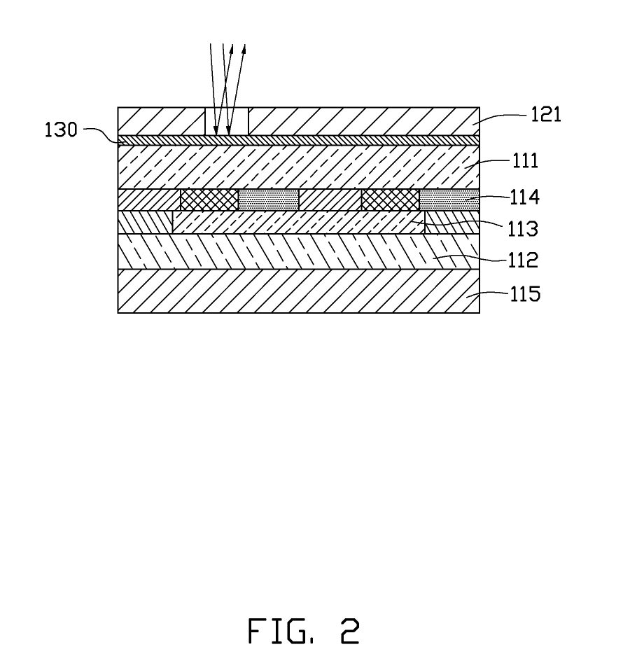

Referring also to FIG. 2, the photo etching barrier layer 130 is formed between the first transparent ITO film 121 and the LCD panel 110. When the first transparent ITO film 121 is etched by ultraviolet laser or infrared laser, the photo etching barrier layer 130 can absorb or reflect the ultraviolet light or the infrared light, thereby preventing the color filter 114 and the liquid crystal layer 113 from being etched by the ultraviolet light or the infrared light. Therefore, lighting performances of the LCD panel 110 can not be affected by the etching of the first transparent ITO film 121. In addition, since the thin film transistor array is formed under the photo etching barrier layer 130, the photo etching barrier layer 130 can also prevent the thin film transistor array from being etched by the ultraviolet light or the infrared light.

The touch display panel is not limited to above embodiments.

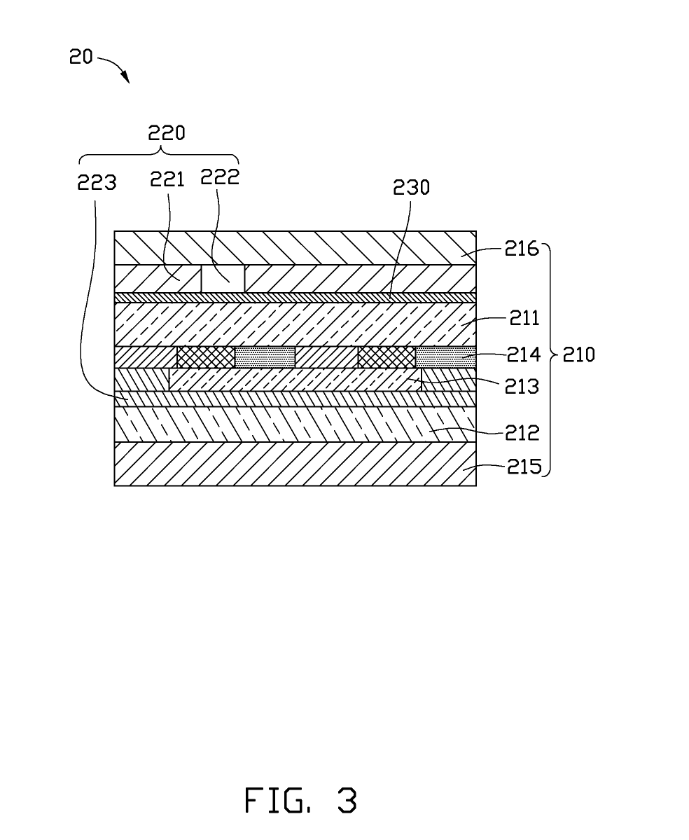

Referring to FIG. 3, a touch display panel 20 in accordance with a second embodiment is provided. The touch display panel 20 includes an LCD panel 210, a touch structure 220 formed on the LCD panel 210, and a photo etching barrier layer 230 formed between the touch structure 220 and the LCD panel 210.

The LCD panel 210 includes a first substrate 211, a second substrate 212 and a liquid crystal layer 213 formed between the first substrate 211 and the second substrate 212. The first substrate 211 and the second substrate 212 are made of glass. A color filter 214 is formed on a bottom surface of the first substrate 211 adjacent to the liquid crystal layer 213 by depositing or coating. A thin film transistor array is formed on an upper surface of the second substrate 212 adjacent to the liquid crystal layer 213 to drive the LCD panel 210. In this embodiment, a first polarizer 215 is formed on a bottom surface of the second substrate 212 away from the liquid crystal layer 213. A second polarizer 216 is formed on an upper surface of the touch structure 220 away from the LCD panel 210. The first polarizer 215 and the second polarizer 216 are configured to be passed through by a polarized light with a predetermined direction.

The touch structure 220 includes a first transparent ITO film 221 and a second transparent ITO film 223. The first transparent ITO film 221 is formed on an upper surface of the first substrate 211, and the first transparent ITO film 221 defines a plurality of channels 222 to be patterning. The second transparent ITO film 223 is formed between the liquid crystal layer 213 and the second substrate 212, and located above the thin film transistor array.

The photo etching barrier layer 230 is formed between the first transparent ITO film 221 and the first glass substrate 211. The photo etching barrier layer 230 is configured to prevent the channel 222 in the first transparent ITO film 221 from extending to the LCD panel 210. In this embodiment, the photo etching barrier layer 230 is made of a material to absorb or reflect ultraviolet light or infrared light. For example, the photo etching barrier layer 230 can be made of organics such as polyimide and propyl acetate. Also, the photo etching barrier layer 230 can be an adhesive layer filled with metallic particles. The metallic particles include Al, Cu, Ag, Pd, Ni or alloys thereof Furthermore, the photo etching barrier layer 230 can be formed by stacking of a plurality of reflective films such as TiO₂ films, ZnO films or SnO₂ films. When the first transparent ITO film 221 is etched by ultraviolet laser or infrared laser, the photo etching barrier layer 230 can absorb or reflect the ultraviolet light or the infrared light, thereby preventing the color filter 214 and the liquid crystal layer 213 from being etched by the ultraviolet light or the infrared light. Therefore, lighting performances of the LCD panel 210 can not be affected by the etching of the first transparent ITO film 221. In addition, since the thin film transistor array is formed under the photo etching barrier layer 230, the photo etching barrier layer 230 can also prevent the thin film transistor array from being etched by the ultraviolet light or the infrared light.

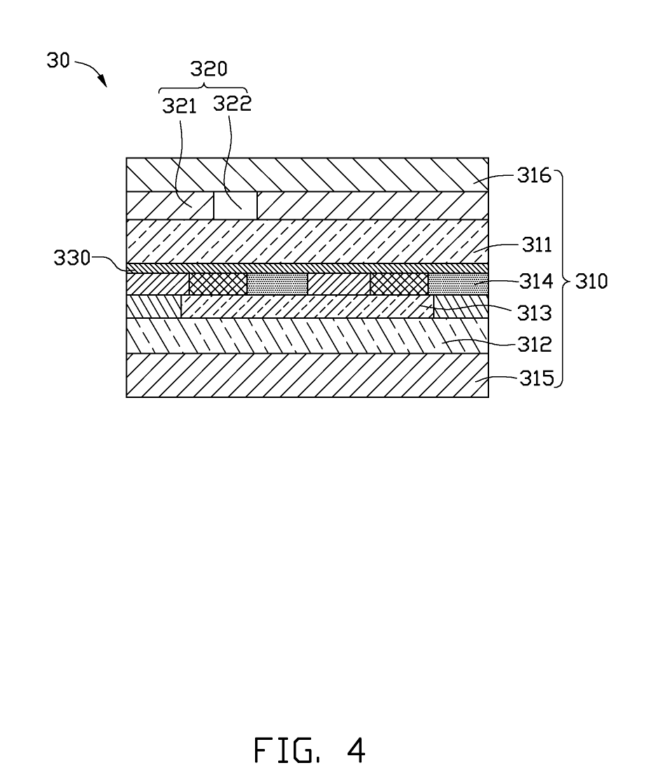

Referring to FIG. 4, a touch display panel 30 in accordance with a third embodiment is provided. The touch display panel 30 includes an LCD panel 310, a touch structure 320 formed on the LCD panel 310, and a photo etching barrier layer 230 formed under the touch structure 220 and inside the LCD panel 210.

The LCD panel 310 includes a first substrate 311, a second substrate 312 and a liquid crystal layer 313 formed between the first substrate 311 and the second substrate 312. The first substrate 311 and the second substrate 312 are made of glass. A color filter 314 is formed on a bottom surface of the first substrate 311 adjacent to the liquid crystal layer 313 by depositing or coating. A thin film transistor array is formed on an upper surface of the second substrate 312 adjacent to the liquid crystal layer 313 to drive the LCD panel 310. In this embodiment, a first polarizer 315 is formed on a bottom surface of the second substrate 312 away from the liquid crystal layer 313. A second polarizer 316 is formed on an upper surface of the touch structure 320 away from the LCD panel 310. The first polarizer 315 and the second polarizer 316 are configured to be passed through by a polarized light with a predetermined direction.

The touch structure 320 includes a first transparent ITO film 321 formed on an upper surface of the first substrate 311. The first transparent ITO film 321 defines a plurality of channels 322 to be patterning.

The photo etching barrier layer 330 is formed between first substrate 311 and the color filter 314. The photo etching barrier layer 330 is configured to prevent the channel 322 in the first transparent ITO film 321 to extend to the LCD panel 310. In this embodiment, the photo etching barrier layer 330 is made of a material to absorb or reflect ultraviolet light or infrared light. For example, the photo etching barrier layer 330 can be made of organics such as polyimide and propyl acetate. Also, the photo etching barrier layer 330 can be an adhesive layer filled with metallic particles. The metallic particles include Al, Cu, Ag, Pd, Ni or alloys thereof. Furthermore, the photo etching barrier layer 330 can be formed by stacking of a plurality of reflective films such as TiO₂ films, ZnO films or SnO₂ films. When the first transparent ITO film 321 is etched by ultraviolet laser or infrared laser, the photo etching barrier layer 330 can absorb or reflect the ultraviolet light or the infrared light, thereby preventing the color filter 314 and the liquid crystal layer 313 from being etched by the ultraviolet light or the infrared light. Therefore, lighting performances of the LCD panel 310 can not be affected by the etching of the first transparent ITO film 321. In addition, since the thin film transistor array is formed under the photo etching barrier layer 330, the photo etching barrier layer 330 can also prevent the thin film transistor array from being etched by the ultraviolet light or the infrared light.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A touch display panel, comprising:
an LCD panel, comprising a first substrate, a second substrate and a liquid crystal layer formed between the first substrate and the second substrate, a color filter being formed on a bottom surface of the first substrate adjacent to the liquid crystal layer;
a touch structure formed on the LCD panel, the touch structure comprising a first transparent ITO film, the first transparent ITO film defines a plurality of channels thereon;
a photo etching barrier layer formed between the first transparent ITO film and the color filter, the photo etching barrier layer being configured to prevent the channels from extending to the color filter and the liquid crystal layer.

2. The touch display panel of claim 1, wherein the photo etching barrier layer is made of organics to absorb ultraviolet light.

3. The touch display panel of claim 2, wherein the photo etching barrier layer is made of a material selected from polyimide and propyl acetate.

4. The touch display panel of claim 1, wherein the photo etching barrier layer is an adhesive layer filled with metallic particles.

5. The touch display panel of claim 4, wherein the metallic particles is made of a material selected from Al, Cu, Ag, Pd, Ni and alloys thereof

6. The touch display panel of claim 1, wherein the photo etching barrier layer comprises a plurality of reflective films stacked together.

7. The touch display panel of claim 6, wherein the reflective films are made of a material selected from TiO₂, ZnO and SnO₂.

8. The touch display panel of claim 1, wherein the photo etching barrier layer is formed on an upper surface of the first substrate adjacent to the touch structure, a first polarizer is formed on a bottom surface of the second substrate, a second polarizer is formed on an upper surface of the first transparent ITO film.

9. The touch display panel of claim 8, further comprising a second transparent ITO film, the second transparent ITO film is formed between the liquid crystal layer and the second substrate.

10. The touch display panel of claim 8, wherein the photo etching barrier layer is made of organics to absorb ultraviolet light.

11. The touch display panel of claim 10, wherein the photo etching barrier layer is made of a material selected from polyimide and propyl acetate.

12. The touch display panel of claim 8, wherein the photo etching barrier layer is an adhesive layer filled with metallic particles.

13. The touch display panel of claim 12, wherein the metallic particles is made of a material selected from Al, Cu, Ag, Pd, Ni and alloys thereof

14. The touch display panel of claim 8, wherein the photo etching barrier layer comprises a plurality of reflective films stacked together.

15. The touch display panel of claim 14, wherein the reflective films are made of a material selected from TiO₂, ZnO and SnO₂.

16. The touch display panel of claim 1, wherein the photo etching barrier layer is formed between the first substrate and the color filter, a first polarizer is formed on a bottom surface of the second substrate, and a second polarizer is formed on an upper surface of the first ITO film.

17. The touch display panel of claim 16, wherein the photo etching barrier layer is made of organics to absorb ultraviolet light.

18. The touch display panel of claim 17, wherein the photo etching barrier layer is made of a material selected from polyimide and propyl acetate.

19. The touch display panel of claim 16, wherein the photo etching barrier layer comprises a plurality of reflective films stacked together.

20. The touch display panel of claim 19, wherein the reflective films are made of a material selected from TiO₂, ZnO and SnO₂.
